(19) United States
(12) Patent Application Publication
(10) Pub. No.: US 2026/0012228 A1
(43) Pub. Date: Jan. 8, 2026

(54) METHODS FOR TARGET POSITION ESTIMATION BASED ON DISTRIBUTED RECONFIGURABLE INTELLIGENT SURFACE (RIS) TRANSMISSIVE ARRAYS

(71) Applicant: CHONGQING UNIVERSITY OF POSTS AND TELECOMMUNICATIONS, Chongqing (CN)

(72) Inventors: Dan WANG, Chongqing (CN); Xin XU, Chongqing (CN); Fatang CHEN, Chongqing (CN); Huahua WANG, Chongqing (CN); Fang LEI, Chongqing (CN)

(73) Assignee: CHONGQING UNIVERSITY OF POSTS AND TELECOMMUNICATIONS, Chongqing (CN)

(21) Appl. No.: 19/329,540

(22) Filed: Sep. 15, 2025

Related U.S. Application Data
(63) Continuation-in-part of application No. PCT/CN2025/081789, filed on Mar. 11, 2025.

(30) Foreign Application Priority Data
Jun. 6, 2024 (CN) 202410729322.3

(51) Int. Cl. H04B 7/04; G01S 5/02

(52) U.S. Cl. CPC H04B 7/04013; G01S 5/0273

(57) ABSTRACT

A method for target position estimation based on a distributed reconfigurable intelligent surface (RIS) transmissive array is provide, including: configuring distributed RISs as an RIS transmissive array, wherein the distributed RISs include two RIS transmissive array surfaces, a target source and receiving radio frequency (RF) chains are respectively disposed on two sides of the RIS transmissive array, the receiving RF chains are connected to receiving antennas, and the target source emits a pilot signal into space; transmitting the pilot signal through the RIS transmissive array to the receiving RF chains to obtain a received signal; determining an azimuth angle β and an elevation angle α of the target source relative to each of the two RIS transmissive array surfaces by processing the received signal; and constructing two rays respectively passing through centers of the two RIS transmissive array surfaces based on the azimuth angles β and the elevation angles α of the target source relative to the two RIS transmissive array surfaces, determining a median of a shortest distance between the two rays, and determining a position of the median as a position of the target source.

### CROSS-REFERENCE TO RELATED APPLICATIONS

This application is a Continuation-in-part of International Patent Application No. PCT/CN2025/081789, filed on Mar. 11, 2025, which claims priority to Chinese Patent Application No. 202410729322.3, filed on Jun. 6, 2024, the contents of each of which are hereby incorporated by reference.

### TECHNICAL FIELD

The present disclosure relates to a field of wireless communication, and in particular to a method for target position estimation based on a distributed reconfigurable intelligent surface (RIS) transmissive array.

### BACKGROUND

Radio positioning and sensing are becoming increasingly important in fifth-generation (5G) wireless communication systems. Position perception is critical to the success of numerous services, including the Internet of Things (IoT), integrated sensing and communication (ISAC) technologies, and autonomous vehicles. At the same time, high-precision positioning technology is also a foundation for many applications, such as emergency rescue, autonomous driving, and healthcare. Currently, the most common way to determine a position is through a Global Navigation Satellite System (GNSS). However, in scenarios such as indoor environments, underground tunnels, and inside buildings, the positioning performance of the GNSS degrades significantly or even becomes unavailable due to blocked or interfered satellite signals.

A Reconfigurable Intelligent Surface (RIS) can actively regulate wireless propagation channels by controlling metamaterial elements through software, providing a new approach to improve positioning performance. When RISs are used as a transmissive array, each RIS element can individually change the phase of a signal passing through it, allowing the signal to be transmitted through the transmissive RIS to form a directional beam. By deploying transmissive RISs to replace building walls, wireless signals from outdoors can be accurately focused on an indoor user, assisting in the outdoor perception and communication of the indoor user's position, which not only enhances communication quality and reduces electromagnetic pollution but also represents an important development direction for ISAC. However, existing technologies that use a single transmissive RIS for target position estimation still suffer from insufficient positioning accuracy and prolonged computational time for position resolution in simulations.

Therefore, it is desirable to provide a method for target position estimation based on a distributed reconfigurable intelligent surface (RIS) transmissive array, which can effectively improve positioning accuracy, computational efficiency, and adaptability to complex scenarios.

### SUMMARY

One or more embodiments of the present disclosure provide a method for target position estimation based on a distributed RIS transmissive array, comprising: configuring distributed RISs as an RIS transmissive array, wherein the distributed RISs include two RIS transmissive array surfaces, a target source and receiving radio frequency (RF) chains are respectively disposed on two sides of the RIS transmissive array, the receiving RF chains are connected to receiving antennas, and the target source emits a pilot signal into space; transmitting the pilot signal through the RIS transmissive array to the receiving RF chains to obtain a received signal; determining an azimuth angle β and an elevation angle α of the target source relative to each of the two RIS transmissive array surfaces by processing the received signal; and constructing two rays respectively passing through centers of the two RIS transmissive array surfaces based on the azimuth angles β and the elevation angles α of the target source relative to the two RIS transmissive array surfaces, determining a median of a shortest distance between the two rays, and determining a position of the median as a position of the target source.

The beneficial effects brought about by the present disclosure include, but are not limited to: effectively improving the redundancy of spatial information through the collaboration of two RISs, facilitating full-space and full-dynamic target perception in complex industrial scenarios, achieving high-precision target position estimation, and resolving the issue of long simulation computation time.

### BRIEF DESCRIPTION OF THE DRAWINGS

The present disclosure is further described through exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating a model of a distributed RIS transmissive array-assisted positioning system according to some embodiments of the present disclosure;

FIG. 2 is a schematic diagram illustrating exemplary hardware and software components of an exemplary computing device according to some embodiments of the present disclosure;

FIG. 3 is a flowchart illustrating an exemplary process of a method for target position estimation based on a distributed RIS transmissive array according to some embodiments of the present disclosure;

FIG. 4 is a schematic diagram illustrating definitions and divisions of near-field and far-field regions according to some embodiments of the present disclosure;

FIG. 5 is a schematic diagram illustrating a principle for determining a shortest distance between non-coplanar lines according to some embodiments of the present disclosure; and

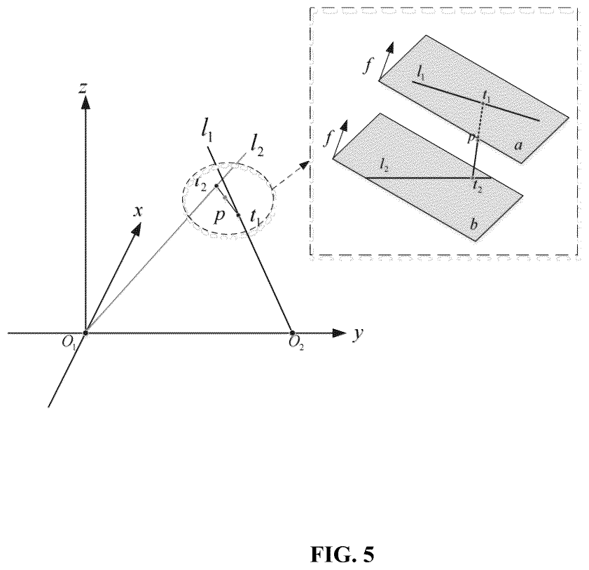

FIG. 6 is a performance comparison diagram between the system of the present disclosure and a single RIS-assisted positioning system during simulation verification according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure.

Those skilled in the art, without further creative efforts, may apply the present disclosure to other similar scenarios according to these drawings. Unless obviously obtained from the context or the context illustrates otherwise, the same numeral in the drawings refers to the same structure or operation.

It will be understood that the terms “system,” “engine,” “unit,” “module,” and/or “block” used herein are one way to distinguish different components, elements, parts, sections, or assemblies of different levels in ascending order. However, the terms may be displaced by other expressions if they may achieve the same purpose.

The singular forms “a”, “an”, and “the” may be intended to include the plural forms as well, unless the context clearly indicates otherwise. The term “and/or”, as used herein, is merely a way of describing the associative relationship of an associated object, indicating that three relationships can exist, e.g., A and/or B, which may be represented as: An alone, both A and B, and B alone. Generally, the terms “include” and/or “comprise”, when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

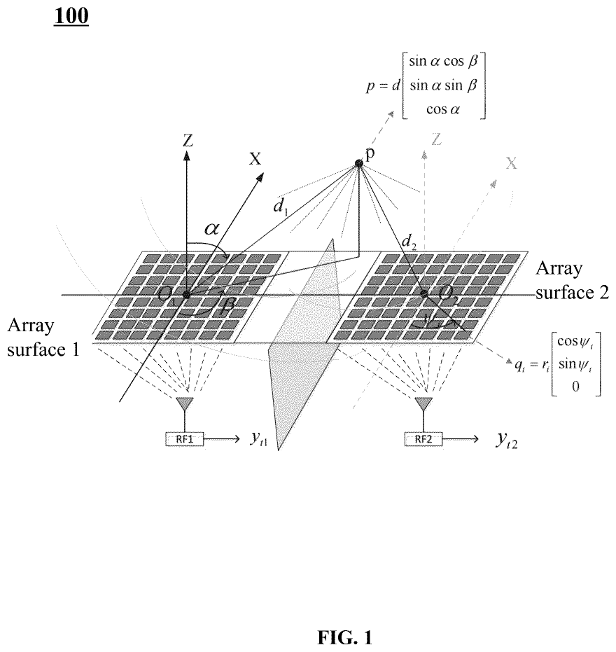

FIG. 1 is a schematic diagram illustrating a model of a distributed RIS transmissive array-assisted positioning system according to some embodiments of the present disclosure.

In some embodiments, as shown in FIG. 1, the distributed RIS transmissive array-assisted positioning system includes distributed RIS transmissive arrays, receiving Radio Frequency (RF) antennas, and a target source p.

A RIS transmissive array refers to a transmissive functional structure composed of Reconfigurable Intelligent Surfaces (RISs). Through a large number of programmable electromagnetic elements in the array, the RIS transmissive array regulates a phase, an amplitude, or a polarization state of an incident wireless signal (e.g., an RF signals, a millimeter wave, etc.) and then allows the signal to transmit from one side of the array to the other side instead of being reflected back to the original direction. In some embodiments, the RIS transmissive array may include electromagnetic regulation array elements, an array substrate, or the like.

The distributed RIS transmissive array refers to a system in which a plurality of RIS transmissive array surfaces (usually 2 or more) are deployed in a distributed manner to work collaboratively. In some embodiments, the distributed RIS transmissive array may be configured with two RIS transmissive array surfaces (a first RIS transmissive array surface and a second RIS transmissive array surface as shown in FIG. 1) arranged side by side, wherein each of the two RIS transmissive array surfaces is connected to a receiving antenna RF (RF1 connected to the first RIS transmissive array surface and RF2 connected to the second RIS transmissive array surface as shown in FIG. 1), the two receiving antennas RF (including the RF1 connected to the first RIS transmissive array surface and the RF2 connected to the second RIS transmissive array surface as shown in FIG. 1) and the target source p (which is a single target source) are disposed on two sides of the distributed RIS transmissive array, respectively. For example, the receiving antennas RF1, RF2 are disposed on one side of the RIS transmissive array surfaces, and the target source p is disposed on the opposite side of the RIS transmissive array surfaces. It should be noted that the specific position of the target source is not limited in the present disclosure, as long as the positions of the target source and the receiving antennas are on opposite sides of the transmissive array surface.

A three-dimensional coordinate system (x, y, z) is constructed with a center (O1 and O2 as shown in FIG. 1) of each RIS transmissive array surface as an origin. The center of a RIS transmissive array surface refers to a geometric center position of the RIS transmissive array surface. d₁ denotes a Euclidean distance from the target source to the geometric center position of the first RIS transmissive array surface, and d₂ denotes a Euclidean distance from the target source to the geometric center position of the second RIS transmissive array surface. α₁ denotes an elevation angle formed by a pilot signal and the first RIS transmissive array surface, and β₁ denotes an azimuth angle formed by the pilot signal and the first RIS transmissive array surface. α₂ denotes an elevation angle formed by the pilot signal and the second RIS transmissive array surface, and β₂ denotes an azimuth angle formed by the pilot signal and the second RIS transmissive array surface. ψ₁ denotes an azimuth angle, which is an angle between a line connecting an i-th array element in each RIS transmissive array surface to the origin and a positive direction of an X axis. rᵢ denotes a distance from the i-th array element in each RIS transmissive array surface to the center of the RIS transmissive array surface. qᵢ denotes a coordinate of the i-th array element in each RIS transmissive array surface. qᵢ may be determined using Equation (1):

$${q}_{i} = [ \begin{matrix}cos {ψ}_{i} \\ sin {ψ}_{i} \\ 0\end{matrix} ] . \qquad ( 1 )$$

The target source refers to a device that needs to be positioned and is capable of emitting a pilot signal. In some embodiments, the target source actively emits the pilot signal with a known characteristic (e.g., an RF signal with a specific frequency and a modulation mode). The pilot signal carries a characteristic (e.g., a fixed sequence) that may be identified by a receiving RF chain, so that the receiving RF chain extracts angle information.

In some embodiments, the target source p may emit a signal, which is transmitted through the RIS transmissive array to the receiving antenna RF to obtain a received signal. The target source p may include a user in a communication system.

In some embodiments, the position of the target source p may be expressed as ρ=[x, y, z]^{T}, where x, y, z denotes coordinates, x, y∈R³, and z>0. O₁ and O₂ denote the center of the first RIS transmissive array surface and the center of the second RIS transmissive array surface respectively. The Euclidean distances from the target source to the center of the first RIS transmissive array surface and the center of the second RIS transmissive array surface are d₁ and d₂, respectively, and d [symbol] ∥ρ∥. A receiving antenna RF is arranged below each RIS transmissive array surface, which is λ (λ is a wavelength of the pilot signal) away from the RIS transmissive array surface. Output signals of the first receiving antenna RF1 and the second receiving antenna RF2 are yₜ_{₁} and yₜ_{₂}, respectively.

In some embodiments, each of the two RIS transmissive array surfaces includes M array elements, and each array element has a size of A=a×a (in general, an area of each array element is set to λ²/4)). A position of an i-th array element in each RIS transmissive array surface is expressed as qᵢ=[xᵢ, yᵢ, zᵢ]^{T}, xᵢ, yᵢ, E R³, zᵢ>0, i=1,2, . . . , M, wherein M is a positive integer denoting a total count of array elements, rᵢ denotes a distance from the i-th array element in the RIS transmissive array surface to the center of the RIS transmissive array surface. The azimuth angle ψᵢ denotes an angle between a line connecting the i-th array element in each RIS transmissive array surface to the origin and the positive direction of the X axis. β₁ and α₁ denote an azimuth angle and an elevation angle of the target source relative to the first RIS transmissive array surface, respectively. β₂ and α₂ denote and an azimuth angle and an elevation angle of the target source relative to the second RIS transmissive array surface, respectively. α₁ and α₂ are collectively referred to as α_{g}, α_{g},

$${α}_{g} ∈ [ 0 , \frac{π}{2} ] ( g = 1 , 2 ) .$$

Hereinafter, α₁ and α₂ may not be distinguished in subsequent expressions, α_{g} may be abbreviated as α. β₁ and β₂ are collectively referred to as β_{g}, β_{g}∈[0,2π](g=1,2). Hereinafter, β₁ and β₂ may not be distinguished in subsequent expressions, β_{g} may be abbreviated as β. The azimuth angle β refers to an angle between the positive direction of the X axis and a projection of the line connecting the target source to the center of the RIS transmissive array surface on an xoy plane. The elevation angle α refers to an angle between a positive direction of a Z axis and the line connecting the target source to the center of the array surface. α and β may be referred to as Angle of Arrivals (AoAs).

Merely by way of example, a wave vector c_{g}(α_{g}, β_{g}) of the signal arriving at each RIS transmissive array surface may be determined by Equation (2):

$${c}_{g} ( {α}_{g} , {β}_{g} ) = - \frac{2 π}{λ} [ \begin{matrix}sin {α}_{g} cos {β}_{g} \\ sin {α}_{g} sin {β}_{g} \\ cos {α}_{g}\end{matrix} ] ( g = 1 , 2 ) , \qquad ( 2 )$$

where c_{g} (α_{g}, β_{g}) denotes the wave vector of the pilot signal arriving at a g-th RIS transmissive array surface, λ denotes the wavelength of the pilot signal. α_{g} denotes the elevation angle formed by the pilot signal and the g-th RIS transmissive array surface, and α_{g} is abbreviated as α. β_{g} denotes the azimuth angle formed by the pilot signal and the g-th RIS transmissive array surface, and β_{g} is abbreviated as β.

After transformation, a position vector of the target source is expressed by the wave vector using Equation (3):

$$p = - \frac{λ {d}_{g} {c}_{g} ( {a}_{g} , {β}_{g} )}{2 π} ( g = 1 , 2 ) , \qquad ( 3 )$$

where p denotes the position vector of the target source, d_{g} denotes the Euclidean distance from the target source to the center of the g-th RIS transmissive array surface. When the RIS transmissive array surfaces are not distinguished in subsequent expressions, d_{g} will be abbreviated as β.

In the distributed RIS transmissive array-assisted positioning system constructed in the embodiments of the present disclosure, it is default that there is no mutual influence between the two receiving antennas connected to the two RIS transmissive array surfaces.

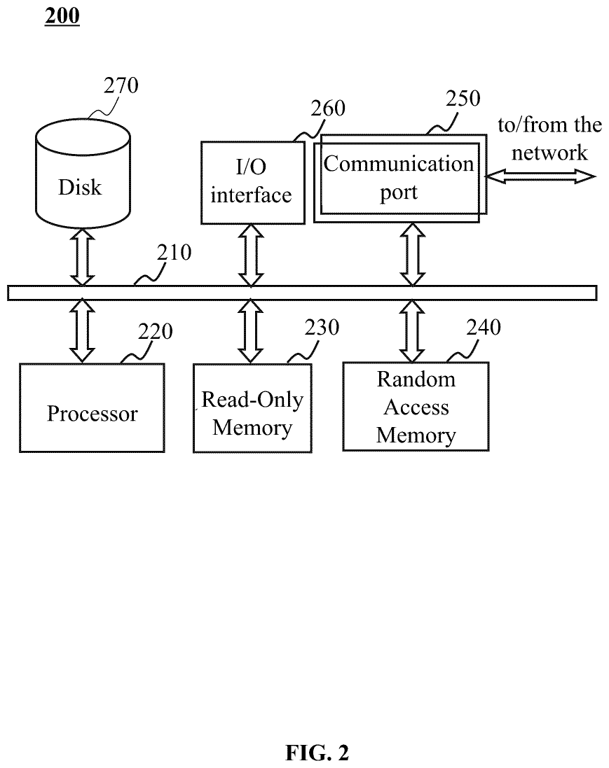

FIG. 2 is a schematic diagram illustrating exemplary hardware and software components of an exemplary computing device according to some embodiments of the present disclosure. A computing device 200 is configured to execute a method for target position estimation based on a distributed RIS transmissive array disclosed in the embodiments of the present disclosure.

The computing device 200 may be a general-purpose computer or a special-purpose computer, both of which may be configured to implement the method for target position estimation based on the distributed RIS transmissive array of the present disclosure. For convenience, only one computer is shown in FIG. 2, but the computer functions related to the method for target position estimation based on the distributed RIS transmissive array described in the present disclosure may be implemented in a distributed manner on a plurality of similar platforms to disperse the processing load.

For example, the computing device 200 may include a communication port 250 that is connected to and/or from a network for data communication. The computing device 200 may also include one or more processors 220 for executing program instructions. Exemplary computer platforms may include an internal communication bus 210, different types of program and data storage devices (e.g., a disk 270, a Read-Only Memory (ROM) 230, or a Random Access Memory (RAM) 240), and various data files processed and/or transmitted by the computer. The exemplary computer platforms also include program instructions stored in the ROM 230, RAM 240, and/or other forms of non-transitory storage media and executed by the processor 220. The methods and/or processes of the present disclosure may be implemented in the form of program instructions. The computing device 200 may also include an Input/Output (I/O) interface 260 that supports input/output between the computer and other components. The computing device 200 may receive programs and data through network communication.

For illustrative purposes only, only one CPU and/or processor is described in the computing device 200. However, it should be noted that the computing device 200 in the present disclosure may include a plurality of CPUs and/or processors. Therefore, the operations and/or the methods described in the present disclosure as being implemented by one CPU and/or processor may also be implemented jointly or independently by the plurality of CPUs and/or processors. For example, if in the present disclosure, the CPU and/or processor of the computing device 200 executes operation A and operation B, it should be understood that operation A and operation B may also be executed jointly or independently by two different CPUs and/or processors in the computing device 200 (e.g., a first processor executes operation A, a second processor executes operation B, or the first and second processors jointly execute operations A and B).

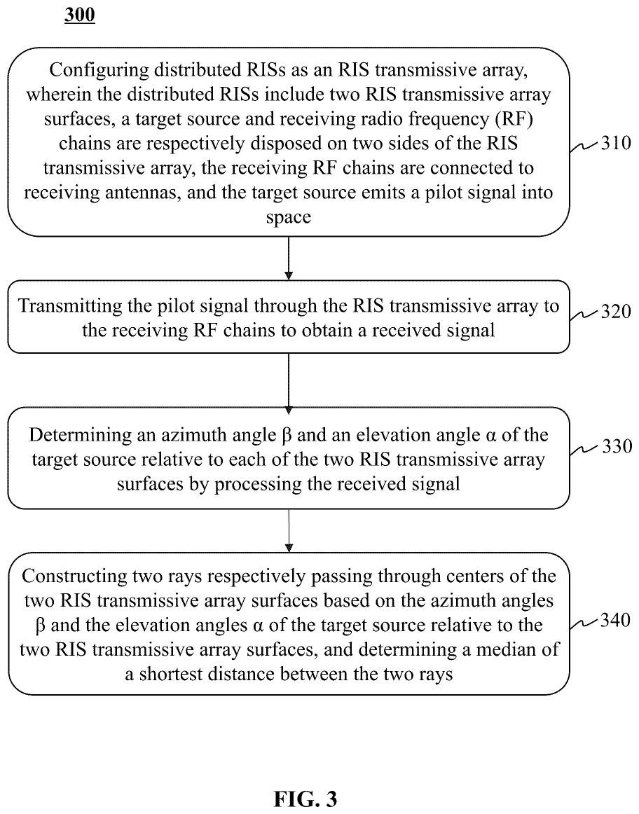

FIG. 3 is a flowchart illustrating an exemplary process of a method for target position estimation based on a distributed RIS transmissive array according to some embodiments of the present disclosure. In some embodiments, a process 300 may be executed by a computing device. As shown in FIG. 3, the process 300 includes the following steps.

In 310, the processor configures distributed RISs as an RIS transmissive array, wherein the distributed RISs include two RIS transmissive array surfaces. A target source and receiving radio frequency (RF) chains are respectively disposed on two sides of the RIS transmissive array. The receiving RF chains are connected to receiving antennas, and the target source emits a pilot signal into space.

The distributed RISs refer to a distributed array system composed of a plurality of independent RIS transmissive array surfaces. The plurality of independent RIS transmissive array surfaces are deployed in a scattered manner (e.g., side by side, at a certain distance, etc.) in space according to a certain layout, and realize the regulation of wireless signal transmission, reflection, or beamforming through collaborative work, thereby enhancing communication performance or improving positioning accuracy.

In some embodiments, the distributed RISs include two RIS transmissive array surfaces. Each of the two RIS transmissive array surfaces corresponds to an independent receiving RF chain to separately process the signal transmitted by the RIS transmissive array surface and avoid signal crosstalk.

The receiving RF chain refers to a circuit module connecting the receiving antenna and a signal processing unit. In some embodiments, the receiving RF chain is responsible for converting an RF signal output by the RIS transmissive array into a processable baseband signal, completing signal processing such as signal amplification, filtering, frequency conversion, and providing raw data for subsequent angle estimation and positioning calculation. In some embodiments, the receiving RF chain may include a receiving antenna, a low-noise amplifier, a filter, or the like.

In some embodiments, the target source and the receiving RF chains are respectively disposed on two sides of the RIS transmissive array, the receiving RF chains are connected to the receiving antennas, and the target source emits the pilot signal into space. The pilot signal is transmitted to the receiving RF chain through the RIS transmissive array, and the processor obtains a received signal. More descriptions regarding the target source, the receiving antenna and the RIS transmissive array may be found in FIG. 1 and relevant descriptions thereof.

In 320, the processor transmits the pilot signal through the RIS transmissive array to the receiving RF chains to obtain the received signal.

In some embodiments, the processor performs signal modeling on the pilot signal transmitted by the target source. For example, assuming the modeled signal is a narrow-band signal, the pilot signal Sₜ emitted by the target source at a time point t is transmitted to a receiver connected to a single antenna through lens on the RIS, and E{|sₜ|²}=Eₛ, t=1,2, . . . , T, Eₛ denotes an average power of the pilot signal, T denotes a count of time points. There are M array elements on each RIS transmissive array surface. At the time point t, the phase of the array element may be expressed as Ωₜ=diag(u_{t,0}, . . . , u_{t,M-1}), where the absolute value of the phase of an i-th array element at the time point t is equal to 1, that is: |u_{t,i}|=1, ∀i=0,1, . . . , M−1.

In some embodiments, at the time point t, an output signal of the receiving antenna yₜ (also referred to as the received signal yₜ) may be determined by Equation (4):

$${y}_{t} = {e}^{j θ} {g}_{ant}^{T} {Ω}_{t} ( ζ ( p ) ∘ b ( p ) ) {s}_{t} + {n}_{t} , \qquad ( 4 )$$

$$wherein ,$$

$$θ = - \frac{2 π d}{λ} + {θ}_{offset} ,$$

$$b ( p ) = \sum {[ b ( p ) ]}_{i} ,$$

$${[ b ( p ) ]}_{i} = exp ( - j \frac{2 π}{λ} ( ‖ p - {q}_{i} ‖ - d ) ) ,$$

$${s}_{t} = \sqrt{{E}_{s}} , ∀ t ,$$

where e denotes a base of a natural logarithm, j denotes an imaginary unit, θ denotes a signal phase, and θ_{offset} denotes a global phase offset. In some embodiments, lack of phase synchronization between an emitter and the receiver and other influences may lead to a phase offset. gₐₙₜ denotes a fixed and known channel gain from the RIS transmissive array surface to the receiving antenna, gₐₙₜ∈ [symbol] , [symbol] denotes a set of M×1 dimensional complex numbers. Ωₜ denotes an RIS array element phase at the time point t. ζ(p) denotes an amplitude vector of the wireless channel between the RIS transmissive array surface and the target source at the time point t, ζ(p)≥0_{M}, 0_{M} denotes an M×M dimensional zero matrix. b(p) denotes a phase vector of the channel, b(p)∈ [symbol] , [b(p)]ᵢ, denotes a phase vector of the i-th array element channel. ∥·∥ denotes a Euclidean distance calculation operation, p denotes the position of the target source, qᵢ denotes a position of the i-th array element in the RIS transmissive array surface. Sₜ denotes the pilot signal transmitted by the target signal source. nₜ denotes a noise at the time point t, which is an additive white Gaussian noise with a mean value of zero and a variance of N₀/2 (assumed to be independent and identically distributed), N₀ denotes a power spectral density of the noise. b(p)=Σ[b(p)]ᵢ denotes that the phase vector of the channel is obtained by summing the phase vector of each array element channel in the RIS transmissive array surface.

In some embodiments, to further simplify Equation (4), the processor introduces a new variable, and sets the signal vector as s=[s₁, s₂, . . . , s_{T}]^{T}. The product of the array element phase and the channel gain at the time point t is expressed as: ωₜ=Ωₜgₐₙₜ, the set consisting of ωₜ denoted by W, W∈ [symbol] , [symbol] denotes the set of M×T dimensional complex numbers. W=[ω₁, ω₂, . . . , ω_{T}], t=1,2, . . . , T, T denotes the count of time points, the noise vector n=[n₁, n₂, . . . , n_{T}]^{T}, and the received signal vector y=[y₁, y₂, . . . , y_{T}]^{T}.

In some embodiments, the processor combines the output signal of the receiving antenna to simplifies Equation (4) as follows:

$$y = {e}^{j θ} diag ( s ) {W}^{T} ( ζ ( p ) ∘ b ( p ) ) + n , \qquad ( 5 )$$

$$wherein ,$$

$$θ = - \frac{2 π d}{λ} + {θ}_{offset} ,$$

$$W = [ {ω}_{1} , {ω}_{2} , … , {ω}_{T} ] ,$$

$${ω}_{t} = {Ω}_{t} {g}_{ant} , t = 1 , 2 , … , T ,$$

$$b ( p ) = \sum {[ b ( p ) ]}_{i} ,$$

where y denotes the output signal of the receiving antenna, e denotes the base of the natural logarithm, j denotes the imaginary unit, θ_{offseet} denotes the global phase offset, λ denotes the wavelength of the pilot signal, d denotes the Euclidean distance from the target source to the center of one of the RIS transmissive array surfaces. ωₜ denotes the product of the array element phase and the channel gain at the time point t, W denotes the set composed of ωₜ, T denotes the count of time points. ζ(p) denotes the amplitude vector of the wireless channel between the RIS transmissive array surface and the target source, ζ(p)≥0_{M}. b(p) denotes the phase vector of the channel, b(p)∈ [symbol] . diag(s) denotes a diagonal matrix operation, and ⋅ denotes a dot product. In some embodiments, the processor sets sₜ=\sqrt{Eₛ}, ∀ₜ, where Eₛ denotes the average power of the pilot signal.

In some embodiments, the processor constructs a channel model to obtain the output signal after passing through the channel model.

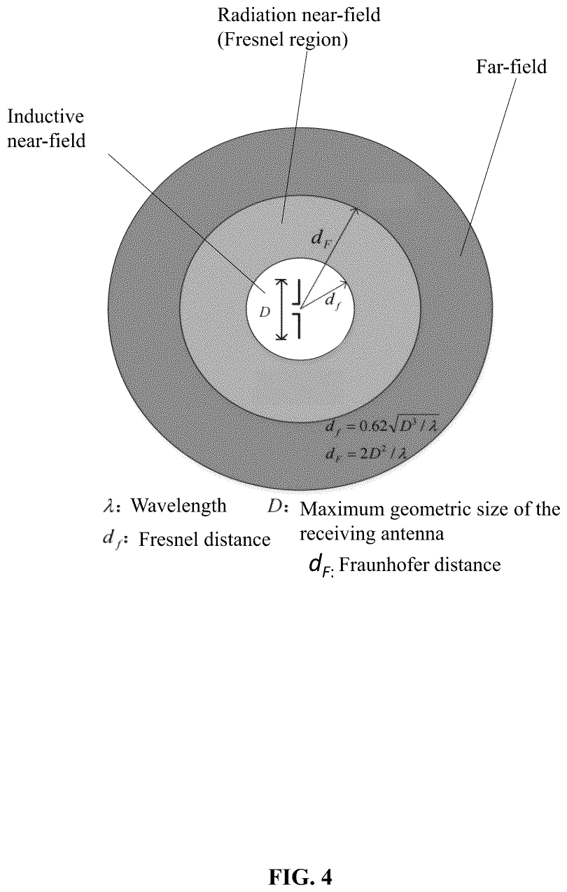

FIG. 4 is a schematic diagram illustrating definitions and divisions of near-field and far-field regions according to some embodiments of the present disclosure.

As shown in FIG. 4, the present disclosure mainly considers a near-field scenario within a Fresnel region beyond a Fresnel distance, while ignoring electromagnetic near-field effects within a Fraunhofer distance. FIG. 4 provides the dividing distances and calculation manners for different regions to illustrate the applicable scope of the channel model in the present disclosure.

In some embodiments, the channel constructed by the processor takes into account changes of an amplitude and a phase of the received signal on RIS array elements, which is close to real positioning scenarios. The amplitude depends on a position of the RIS array element relative to the target source (equivalent to a user). The phase depends on a distance from the signal to each RIS array element. The determination of the array element phase needs to consider a wavefront curvature. The phase vector of an i-th array element channel [b(p)]ᵢ may be determined by Equation (6):

$${[ b ( p ) ]}_{i} = exp ( - j \frac{2 π}{λ} ( ‖ p - {q}_{i} ‖ - d ) ) , \qquad ( 6 )$$

$$wherein :$$

$$‖ p - {q}_{i} ‖ - d = d {( 1 + \frac{{r}_{i}^{2}}{{d}^{2}} - 2 \frac{{r}_{i}}{d sin α cos ( β - α )} )}^{\frac{1}{2}} - d , \qquad ( 7 )$$

where ∥p−qᵢ∥ denotes a Euclidean distance from the target source to the i-th array element in each RIS transmissive array surface. ∥·∥ denotes the Euclidean distance calculation operation. qᵢ denotes the position of the i-th array element in each RIS transmissive array. In some embodiments, when calculating the position coordinates of each RIS transmissive array surface relative to the target source, respectively, the processor establishes a coordinate system with the center of the currently calculated RIS transmissive array surface as the coordinate center. That is to say, the Euclidean distance from the target source to the center of the current RIS transmissive array surface is expressed as d [symbol] p∥ (as shown in FIG. 1, in the system model, the center of the RIS transmissive array surface is the origin of coordinates). rᵢ denotes a distance from the i-th array element to the center of the RIS transmissive array surface. α denotes the elevation angle formed by the pilot signal and the RIS transmissive array surface, and β denotes the azimuth angle formed by the pilot signal and the RIS transmissive array surface.

In some embodiments, when d>>∥qᵢ∥, ∀i, Equation (7) may be expressed as:

$$‖ p - {q}_{i} ‖ - d = - {r}_{i} sin α cos ( β - {ψ}_{i} ) , \qquad ( 8 )$$

where ∥·∥ denotes the Euclidean distance calculation operation, α denotes the elevation angle formed by the pilot signal and each RIS transmissive array surface, β denotes the azimuth angle formed by the pilot signal and each RIS transmissive array surface. ψᵢ denotes the azimuth angle between the line connecting the i-th array element of each RIS transmissive array surface to the center of the RIS transmissive array surface and the positive direction of the X axis. It may be observed from the Equation (7) that the final result has no relation to the distance from the target source to the RIS transmissive array surface.

In some embodiments, an amplitude vector of the channel model may be determined by Equation (9):

$${[ ζ ( p ) ]}_{i}^{2} = {( 12 π )}^{- 1} \times {\sum }_{{x ∈ {X}_{i}}_{y ∈ {Y}_{i}}} \frac{xy}{( {y}^{2} + {z}^{2} ) g ( xy )} + 2 arc tan ( \frac{xy}{{z}^{2} g ( xy )} ) , \qquad ( 9 )$$

$$wherein :$$

$${X}_{i} = \{ a / 2 + ( {x}_{i} - x ) , a / 2 - ( {x}_{i} - x ) \} ,$$

$${Y}_{i} = \{ a / 2 + ( {y}_{i} - y ) , a / 2 - ( {y}_{i} - y ) \} ,$$

$$g ( x , y ) = \sqrt{{x}^{2} / {z}^{2} + {y}^{2} / {z}^{2} + 1} ,$$

where [ζ(p)]ᵢ² denotes the amplitude vector of the channel model, Xᵢ and Yᵢ denote value sets of x and y respectively, a denotes a size of the array element, and let a=λ/2 for convenience.

In some embodiments, after the pilot signal emitted by the target source is transmitted through the channel, the output signal of the receiving antenna may be determined by Equation (10):

$${y}^{′} = \sqrt{{E}_{s}} γ {W}^{T} {G}^{T} ( α ) h ( β ) + n , \qquad ( 10 )$$

$$wherein :$$

$$W = [ {ω}_{1} , {ω}_{2} , ⋯ , {ω}_{T} ] ,$$

$${ω}_{t} = {Ω}_{t} {g}_{ant} , t = 1 , 2 , ⋯ , T ,$$

$$G ( α ) = [ {g}_{0} ( α ) ⋯ {g}_{M - 1} ( α ) ] ,$$

$$h ( β ) = {e}^{j β} ,$$

where y′ denotes the output signal of the receiving antenna, y′ is also referred to as the received signal. Eₛ denotes the average power of the pilot signal, and γ denotes an intermediate variable. γ=ζ(p)e^{jθ}, where ζ(p) denotes an amplitude vector of the wireless channel between each RIS transmissive array surface and the target source, e denotes the base of the natural logarithm, j denotes an imaginary unit. θ denotes a signal phase,

$$θ = - \frac{2 π d}{λ} + {θ}_{offset} ,$$

λ denotes the wavelength of the pilot signal, d denotes the Euclidean distance from the target source to the center of each RIS transmissive array surfaces, θ_{offset} denotes a global phase offset. ωₜ denotes a product of an array element phase and a channel gain at the time point t. W denotes a set composed of ωₜ, T denotes a count of time points, T denotes a transpose operation. α denotes the elevation angle formed by the pilot signal and each RIS transmissive array surface, G(α) denotes an intermediate variable related to the elevation angle α, β denotes the azimuth angle formed by the pilot signal and each RIS transmissive array surface, n denotes a noise vector.

In 330, the processor determines an azimuth angle β and an elevation angle α of the target source relative to each of the two RIS transmissive array surfaces by processing the received signal.

The azimuth angle β refers to an angle between a projection of a line connecting the target source to the center of the RIS transmissive array surface on a horizontal plane (the xoy plane) and a preset reference direction (e.g., the positive direction of the X axis) in the plane. A value range of the azimuth angle β is typically 0°-360°.

The elevation angle α refers to an angle between a line connecting the target source to the center of the RIS transmissive array surface and a normal direction of the RIS transmissive array surface (e.g., the positive direction of the Z axis). A value range of the elevation angle α is typically 0°-90°.

In some embodiments, the processor may perform a Fisher information analysis to design a phase of the RIS transmissive array surface.

When a noise portion of the output signal θ of the receiving antenna is ignored, the intermediate variable may be set as μ=\sqrt{Eₛ}ζ(p)e^{jθ}W^{T}b(p), wherein an unknown parameter may be set as η=[ζ(p)θp]^{T}.

In some embodiments, a Fisher Information Matrix (FIM) F(η)∈ [symbol] may be determined by Equation (11):

$$F ( η ) = \frac{2}{{N}_{0}} ℛ \{ {( \frac{\partial μ}{\partial η} )}^{H} \frac{\partial μ}{\partial η} \} , \qquad ( 11 )$$

where μ denotes a portion of the output signal of the receiving antenna without considering noise, η denotes the unknown parameter.

In some embodiments, the partial derivatives may be expressed as ∂μ/∂ζ(p)=\sqrt{Eₛ}e^{jθ}W^{T}b(p), ∂μ/∂θ=\sqrt{Eₛ}ζ(p)je^{jθ}W^{T}b(p), ∂μ/∂p=\sqrt{Eₛ}ζ(p)e^{jθ}W^{T}D(p), D(p)∈ [symbol] , and D(p) may be determined by Equation (12):

$$D ( p ) = \frac{\partial b ( p )}{\partial p} = j \frac{2 π}{λ} ( diag ( b ( p ) ) {Q}^{⊤} + b ( p ) \frac{{p}^{⊤}}{d} ) , \qquad ( 12 )$$

where D(p) denotes a phase space change rate of the target source, p denotes a coordinate of the position of the target source. d denotes the Euclidean distance from the target source to the center of each RIS transmissive array surface. b(p)∈ [symbol] denotes the phase vector of the channel. An intermediate variable eᵢ is introduced, eᵢ=(qᵢ−p)/∥qᵢ−p∥, wherein qᵢ denotes the position of the i-th array element in each RIS transmissive array surface, ∥·∥ denotes the Euclidean distance calculation operation, and a set composed of eᵢ is expressed as: Q=[e₀, e₁, . . . , e_{M-1}].

In some embodiments, F(η) denotes the Fisher information matrix of all unknown information. It is necessary to obtain an equivalent FIM information matrix F(p) related to a user position. F(p) may be determined by Equation (13):

$$F ( p ) = {[ F ( η ) ]}_{3 : 5 , 3 : 5} - {{{[ F ( η ) ]}_{3 : 5 , 1 : 2} [ F ( η ) ]}_{1 : 2 , 1 : 2}^{- 1} [ F ( η ) ]}_{1 : 2 , 3 : 5} = \frac{2 {ζ}^{2} {E}_{S}}{{N}_{0}} ℛ \{ {D}^{H} ( p ) [ W * {W}^{⊤} - \frac{W * {W}^{⊤} b ( p ) {b}^{H} ( p ) W * {W}^{⊤}}{{b}^{H} ( p ) W * {W}^{⊤} b ( p )} ] D ( p \} , \qquad ( 13 )$$

where [F(η)]_{1,1} denotes an element in a first row and a first column of the F(η) matrix. [F(η)]_{3:5,3:5} denotes elements in rows 3 to 5 and columns 3 to 5 of the F(η) matrix. [F(η)]_{3:5,1:2} denotes the elements in rows 3 to 5 and columns 1 to 2 of the F(η) matrix. [F(η)]⁻¹_{1:2,1:2} denotes an inverse of the elements in rows 1 to 2 and columns 1 to 2 of the F(η) matrix. [F(η)]_{1:2,3:5} denotes elements in rows 1 to 2 and columns 3 to 5 of the F(η) matrix. N₀ denotes the power spectral density of the noise.

$$( p ) = \frac{\partial b ( p )}{\partial p} = j \frac{2 π}{λ} ( diag ( b ( p ) ) {Q}^{⊤} + b ( p ) \frac{{p}^{⊤}}{d} ) ,$$

* denotes a complex conjugate. The product of the phase and the channel gain is ωₜ=Ωₜgₐₙₜ, so W=[ω₁, ω₂, . . . , ω_{T}]. b(p)∈ [symbol] is the phase vector of the channel. b^{H}(p) denotes a conjugate transpose of the phase vector of the RIS transmissive array surface. ζ(p) denotes the amplitude vector of the wireless channel between the RIS transmissive array surface and the target source.

The present disclosure uses a positioning error bound (PEB) to express positioning performance, which is compared with the performance of other positioning models. The PEB in meters may be determined by Equation (14):

$$PEB = \sqrt{trace ( {[ {F}^{- 1} ( η ) ]}_{3 : 5 , 3 : 5} )} = \sqrt{trace ( [ {F}^{- 1} ( p ) ] )} , \qquad ( 14 )$$

where PEB denotes the positioning error bound, [F⁻¹(η)]_{3:5,3:5} denotes an inverse of the elements in rows 3 to 5 and columns 3 to 5 of the F(η) matrix, trace denotes a trace operation, [F⁻¹(p)] denotes an inverse of the matrix.

In some embodiments, the PEB may be correlated with a Root Mean Square Error (RMSE) of an unbiased estimator \hat{p} through Inequality (15):

$$PEB \leq RMSE {=}^{△} \sqrt{𝔼 \{ {‖ \hat{p} - p ‖}^{2} \}} , \qquad ( 15 )$$

where \hat{p} denotes an estimated position of the target source, ∥·∥ denotes the Euclidean distance calculation operation, p denotes an actual position of the target source set in the simulation, E{·} denotes an expectation calculation.

The performance of the target source position estimation is closely related to the phase design of the RIS transmissive array surface. To eliminate the effect of a fixed known channel gain from the RIS array to a single receiving antenna, the processor designs Ωₜ=Ωₐₙₜ\tilde{Ω}ₜ, where a fixed phase Ωₐₙₜ=diag(ω_{ant,0}, . . . , ω_{ant,M-1}) \tilde{Ω}_{diag}(\tilde{ω}_{t,0}, \tilde{ω}_{t,1}, . . . , \tilde{ω}_{t,M-1})), and [gₐₙₜ^{T}Ωₐₙₜ]ᵢ=|[gₐₙₜ^{T}]ᵢ|, ∀i. The phase of each array element of the RIS array at any time point is set separately. The phase of each array element at the time point t is: (\tilde{ω}_{t,i}=exp(jψ_{t,i}), wherein ψ_{t,1}˜u(0,2π), u(0,2π) denotes uniform distribution from 0 to 2π.

In some embodiments, the processor estimates the elevation angles α of the target source relative to the two RIS transmissive array surfaces respectively based on maximum likelihood estimation. Based on the estimated elevation angles α, the processor obtains the azimuth angles R through maximum likelihood estimation, constructs a geometric relationship model, and determines a most likely position of the target source. That is to say, the processor estimates the position of the target source through a non-coplanar line geometric positioning manner.

In some embodiments, the phase vector b(p) of the channel contains information of the elevation angle α and the azimuth angle β. Therefore, Equation (10) is rewritten as:

$${y}^{′} = \sqrt{{E}_{s}} γ {W}^{T} b ( α , β ) + n , \qquad ( 16 )$$

$$wherein ,$$

$$γ = ζ ( p ) {e}^{j θ} ,$$

$$θ = - \frac{2 π d}{λ} + {θ}_{offset} ,$$

$$W = [ {ω}_{1} , {ω}_{2} , … , {ω}_{T} ] ,$$

$${ω}_{t} = {Ω}_{t} {g}_{ant} , t = 1 , 2 , … , T ,$$

$$b ( α , β ) = \sum {[ b ( α , β ) ]}_{i} ,$$

where y′ denotes the output signal of the receiving antenna after channel transmission, Eₛ denotes the average power of the pilot signal, γ denotes the intermediate variable introduced to simplify Equation (10). ωₜ denotes the product of the array element phase and the channel gain at the time point t. W denotes the set composed of ωₜ, T denotes the count of time points. α and β are the elevation angle and the azimuth angle formed by the signal and each RIS transmissive array surface, respectively. n denotes the noise vector. [b(α,β)]ᵢ denotes a phase vector of the i-th element.

In some embodiments, the processor may simplify the phase vector by ignoring the amplitude change of the pilot signal. The phase vector for the i-th element may be determined by Equation (17):

$${[ b ( α , β ) ]}_{i} = exp ( - j \frac{2 π}{λ} {r}_{i} sin α cos ( β - {ψ}_{i} ) ) , \qquad ( 17 )$$

where [b(α, β)]ᵢ denotes the phase vector of the i-th element. α denotes the elevation angle formed by the pilot signal and each RIS transmissive array surface. β denotes the azimuth angle formed by the pilot signal and each RIS transmissive array surface. λ denotes the wavelength of the pilot signal. ψᵢ denotes an azimuth angle of the RIS array element. rᵢ denotes a distance from the i-th array element in the RIS transmissive array surface to the center of the RIS transmissive array surface.

In some embodiments, the processor re-expresses the above Equation (17) using a Bessel expansion equation as follows:

$${[ b ( α , β ) ]}_{i} = {\sum }_{n = - ∞}^{∞} {j}^{n} {J}_{n} ( - \frac{2 π}{λ} {r}_{i} sin ( α ) ) {e}^{jn ( β - {ψ}_{i} )} , \qquad ( 18 )$$

where Jₙ(·) denotes an n-th order Bessel function, and n typically takes a value of 2. α denotes the elevation angle formed by the pilot signal and each RIS transmissive array surface. β denotes the azimuth angle formed by the pilot signal and each RIS transmissive array surface. λ denotes the wavelength of the pilot signal. ψᵢ denotes the azimuth angle of the i-th array element in each RIS transmissive array surface. rᵢ denotes the distance from the i-th array element in the RIS transmissive array surface to the center of the RIS transmissive array surface.

In some embodiments, by ignoring the case where |n|>N (as n increases, |Jₙ(·)| tends towards zero), the processor may obtain Equation (19):

$${[ b ( α , β ) ]}_{i} \approx {\sum }_{n = - N}^{N} {j}^{n} {J}_{n} ( - \frac{2 π}{λ} {r}_{i} sin ( α ) ) {e}^{jn ( β - {ψ}_{i} )} , \qquad ( 19 )$$

where |Jₙ(·)| denotes the n-th order Bessel function. N denotes a value beyond which the function decays to zero. α denotes the elevation angle formed by the pilot signal and each RIS transmissive array surface. β denotes the azimuth angle formed by the pilot signal and each RIS transmissive array surface. α denotes the wavelength of the pilot signal. ψᵢ denotes the azimuth angle of the i-th array element in each RIS transmissive array surface. rᵢ denotes the distance from the i-th array element in each RIS transmissive array surface to the center of the RIS transmissive array surface.

In some embodiments, the intermediate variable G(α) is expressed as: G(α)=[g₀(α) . . . g_{M-1}(α)], wherein the expression of the i-th element gᵢ(α) related to the elevation angle α is:

$${g}_{i} ( α ) = {j}^{n} {J}_{n} ( - \frac{2 π}{λ} {r}_{i} sin ( α ) ) {e}^{- jn {ψ}_{i}} , i = 0 , … , M - 1 , \qquad ( 20 )$$

$${[ h ( β ) ]}_{n} = {e}^{jn β} , \qquad ( 21 )$$

where gᵢ(α) denotes the i-th element of the intermediate variable G(α) related to the elevation angle α, i denotes an index of the array element, M denotes a count of array elements in each RIS transmissive array surface, Jₙ(·) denotes the n-th order Bessel function, with n=2. j denotes the imaginary unit. α denotes the elevation angle formed by the pilot signal and each RIS transmissive array surface. λ denotes the wavelength of the pilot signal. ψᵢ denotes an angle between the line connecting the i-th array element in each RIS transmissive array surface to the origin and the positive direction of the X axis. rᵢ denotes the distance from the i-th array element in each RIS transmissive array surface to the center of the RIS transmissive array surface.

In some embodiments, the phase vector may be expressed as:

$${[ b ( α , β ) ]}_{i} = {g}_{i}^{T} ( α ) h ( β ) .$$

Let G(α)=[g₀(α) . . . g_{M-1}(α)], then:

$$b ( α , β ) \approx {G}^{T} ( α ) h ( β ) , \qquad ( 22 )$$

$$wherein G ( α ) = [ {g}_{0} ( α ) … {g}_{M - 1} ( α ) ] ,$$

$${g}_{i} ( α ) = {j}^{n} {J}_{n} ( - \frac{2 π}{λ} {r}_{i} sin ( α ) ) {e}^{- jn {ψ}_{i}} , h ( β ) = {e}^{j β} .$$

In some embodiments, the processor expresses the elevation angle α and the azimuth angle β separately, and rewrites Equation (16) to obtain Equation (23):

$${y}^{′} = \sqrt{{E}_{s}} γ {W}^{T} {G}^{T} ( α ) h ( β ) + n , \qquad ( 23 )$$

where y′ denotes the output signal of the receiving antenna after channel transmission.

In some embodiments, the processor obtains an optimization function for the elevation angle α based on the expression of the output signal of the receiving antenna, obtains an estimated value of the elevation angle α by performing a grid search over a range of 0° to 90° for the elevation angle α, and introduces an intermediate variable ν, where ν=\sqrt{Eₛ}γh(β), γ denotes the intermediate variable used to simplify the equation, and γ=ζe^{jθ}. \hat{ν}(α) may be determined by Equation (24):

$$\hat{v} ( α ) = {( {G}^{*} ( α ) {W}^{*} )}^{+} {G}^{*} ( α ) {W}^{*} {y}^{′} . \qquad ( 24 )$$

In some embodiments, the optimization function for the elevation angle α is expressed as:

$$\hat{α} = arg {min}_{α} {‖ {y}^{′} - {W}^{T} {G}^{T} ( α ) \hat{v} ( α ) ‖}^{2} , \qquad ( 25 )$$

where y′ denotes the output signal of the receiving antenna, \hat{α} denotes the estimated value of the elevation angle α, ∥·∥ denotes the Euclidean distance calculation operation, \hat{ν}(α) denotes an estimated value represented as a function of the elevation angle α. G(α)=[g₀(α) . . . g_{M-1}(α)], G*(α) denotes a complex conjugate of G(α), W* denotes a complex conjugate of W.

In some embodiments, the processor may determine elevation angles α₁ and α₂ of the target source relative to the two RIS transmissive array surfaces, respectively. α₁ denotes an elevation angle of the target source relative to the first RIS transmissive array surface, and α2 denotes an elevation angle of the target source to the second RIS transmissive array surface.

In some embodiments, the processor substitutes the estimated value of the elevation angle α into the transformed expression of the output signal of the receiving antenna, obtains an optimization function for the azimuth angle β, and obtains an estimated value of the azimuth angle β by performing a grid search over a range of 0° to 360° for the azimuth angle β, wherein the optimization function for the azimuth angle β is expressed as:

$$\hat{β} = arg {min}_{β} {‖ {y}^{′} - \sqrt{{E}_{s}} \hat{γ} ( β ) {W}^{T} {G}^{T} ( \hat{α} ) h ( β ) ‖}^{2} , \qquad ( 26 )$$

where y′ denotes the output signal of the receiving antenna, referred to as the received signal for short. \hat{β} denotes the estimated value of the azimuth angle β, \hat{γ}(β) denotes a maximum likelihood estimation (MILE) of γ with respect to the azimuth angle β.

In some embodiments, the processor may determine azimuth angles β₁ and β₂ of the target source relative to the two RIS transmissive array surfaces, respectively. β1 denotes an azimuth angle of the target source relative to the first RIS transmissive array surface, and β2 denotes an azimuth angle of the target source relative to the second RIS transmissive array surface.

In some embodiments, the processor may construct the optimization function for solving the azimuth angle β through the following operations.

The processor builds a maximum likelihood estimation model, let γ=ζ(p)e^{jθ} to obtain an MLE of the channel gain and an MLE of the position of the target source, expressed as:

$$[ \hat{γ} , \hat{p} ] = arg {min}_{γ , p} f ( {y}^{′} \vert γ , p ) = arg {min}_{γ , p} {‖ {y}^{′} - \sqrt{{E}_{s}} γ {W}^{T} b ( p ) ‖}^{2} , \qquad ( 27 )$$

where \hat{γ} denotes the MLE of the channel gain, \hat{p} denotes the MLE of the position of the target source.

In some embodiments, the processor solves for an MLE \hat{γ}(p) of \hat{γ} with respect to the position p of the target source based on the MLE of the channel gain. In some embodiments, \hat{γ}(p) may be determined by Equation (28):

$$\hat{γ} ( p ) = \frac{{b}^{H} ( p ) {W}^{*} {y}^{′}}{\sqrt{{E}_{s}} {‖ {W}^{T} b ( p ) ‖}^{2}} , \qquad ( 28 )$$

where W* denotes the complex conjugate of W. y′ denotes the output signal of the receiving antenna after channel transmission. b^{H}(p) denotes the conjugate transpose of b(p).

For simplicity, let sₜ=\sqrt{Eₛ}, ∀t.

In some embodiments, the processor substitutes the estimated value \hat{γ} to obtain the estimated value \hat{p}:

$$\begin{matrix}\hat{p} = arg {max}_{p} {‖ {y}^{′} - \sqrt{{E}_{s}} \hat{γ} ( p ) {W}^{⊤} b ( p ) ‖}^{2} \\ = arg {min}_{p} {‖ {Π}_{L}^{⊥} {y}^{′} ‖}^{2}\end{matrix} , \qquad ( 29 )$$

where \hat{p} denotes the MLE of the position of the target source, ∥·∥ denotes the Euclidean distance calculation operation,

$${Π}_{L}^{⊥}$$

denotes an orthogonal projection operator on L, L=W^{T}b(p) denotes a product between a channel phase gain matrix and the phase vector of the channel.

In some embodiments, the processor substitutes G^{T}(\hat{α})h(β) for b(p) in Equation (28) based on the MLE \hat{γ}(p) of \hat{γ} with respect to the position of the target source p, where b(p)=G^{T}((\hat{α})h(β), to obtain the MLE \hat{γ}(β) of \hat{γ} with respect to the azimuth angle β. In some embodiments, \hat{γ}(β) may be determined by Equation (30):

$$γ ( β ) = \frac{{b}^{H} ( p ) {W}^{*} {y}^{′}}{\sqrt{{E}_{s}} {‖ {W}^{⊤} {G}^{⊤} ( \hat{α} ) h ( β ) ‖}^{2}} , \qquad ( 30 )$$

where \hat{γ}(β) denotes the MILE of γ with respect to the azimuth angle β, G^{T}(\hat{α}) denotes a transpose of G(\hat{α}).

In 340, the processor constructs two rays respectively passing through the centers of the two RIS transmissive array surfaces based on the azimuth angles β and the elevation angles α of the target source relative to the two RIS transmissive array surfaces, and determines a median of a shortest distance between the two rays.

In some embodiments, a position of the median is determined as the position of the target source.

In some embodiments, the processor may respectively obtain a first ray l₁ and a second ray l₂ that pass through the centers of the RIS transmissive array surfaces and have azimuth angles R and elevation angles α corresponding to those of the target source, based on the azimuth angles R and elevation angles α of the target source relative to the first and second RIS transmissive array surfaces respectively.

For the first RIS transmissive array surface, the processor respectively obtains the first ray l₁ that passes through the center of the first RIS transmissive array surface and has an azimuth angle and an elevation angle corresponding to the azimuth angle β and elevation angle α of the target source relative to the first RIS transmissive array surface, based on the azimuth angle β and elevation angle α of the target source relative to the first RIS transmissive array surface.

For the second RIS transmissive array surface, the processor respectively obtains the second ray l₂ that passes through the center of the second RIS transmissive array surface and has an azimuth angle and an elevation angle corresponding to the azimuth angle β and elevation angle α of the target source relative to the second RIS transmissive array surface, based on the azimuth angle β and elevation angle α of the target source relative to the second RIS transmissive array surface.

Merely by way of example, the first ray l₁ and the second ray l₂ may be determined by Equation (31):

$$\begin{matrix}{l}_{1} = {p}_{1} + λ {v}_{1} \\ {l}_{2} - {p}_{2} + τ {v}_{2}\end{matrix} , \qquad ( 31 )$$

$$wherein :$$

$$\begin{matrix}{v}_{1} = {[ {x}_{1}^{′} , {y}_{1}^{′} , {z}_{1}^{′} ]}^{⊤} , \\ \{ \begin{matrix}{x}_{1}^{′} = sin {α}_{1} cos {β}_{1} \\ {y}_{1}^{′} = sin {α}_{1} sin {β}_{1} \\ {z}_{1}^{′} = cos {α}_{1}\end{matrix}\end{matrix} , \qquad ( 32 )$$

$$\begin{matrix}{v}_{2} = {[ {x}_{2}^{′} , {y}_{2}^{′} , {z}_{2}^{′} ]}^{⊤} , \\ \{ \begin{matrix}{x}_{2}^{′} = sin {α}_{2} cos {β}_{2} \\ {y}_{2}^{′} = sin {α}_{2} sin {β}_{2} \\ {z}_{2}^{′} = cos {α}_{2}\end{matrix}\end{matrix} , \qquad ( 33 )$$

where l₁ denotes the first ray that passes through the center of the first RIS transmissive array, l₂ denotes the second ray that passes through the center of the second RIS transmissive array. p₁ denotes the coordinates of a point through which the first ray passes, p₂ denotes the coordinates of a point through which the second ray passes. λ denotes a slope of the first ray, T denotes a slope of the second ray. ν₁ denotes a direction vector of the first ray, ν₂ denotes a direction vector of the second ray. [x′₁, y′₁, z′₁]^{T} denote position coordinates of any point on the first ray, [x′₂, y′₂, z′₂] denote position coordinates of any point on the second ray. T denotes a transpose operation. α₁ denotes the elevation angle of the first ray, β₁ denotes the azimuth angle of the first ray, α₂ denotes the elevation angle of the second ray, β₂ denotes the azimuth angle of the second ray.

In some embodiments, the processor may obtain a vector perpendicular to both the first ray l₁ and the second ray l₂. Merely by way of example, the vector perpendicular to both the first ray l₁ and the second ray l₂ may be determined by Equation (34):

$$f = {v}_{1} \times {v}_{2} , \qquad ( 34 )$$

where ƒ denotes the vector perpendicular to both the first ray l₁ and the second ray l₂., ν₁ denotes the direction vector of the first ray, ν₂ denotes the direction vector of the second ray.

In some embodiments, the processor translates the second ray l₂ along the vector to form a plane a, and obtains an intersection point t₁ between the first ray l₁ and the plane a. The intersection point t₁ is a point on the first ray l₁ closest to the second ray l₂. Merely by way of example, the intersection point t₁ may be determined by Equation (35):

$${t}_{1} = {p}_{1} + \frac{( {p}_{2} - {p}_{1} ) \cdot {f}_{2}}{{v}_{1} \cdot {f}_{2}} {v}_{1} , \qquad ( 35 )$$

where p₁ denotes the coordinates of the point through which the first ray l₁ passes, p₂ denotes the coordinates of the point through which the second ray l₂ passes, ƒ₂ denotes a vector perpendicular to the plane a formed by the second ray l₂.

In some embodiments, the processor translates the second ray l₂ along the vector ƒ perpendicular to the first ray l₁ and the second ray l₂ to form a plane b. The plane b contains the point p₁ and is perpendicular to ƒ₁=ν₁×ƒ. The intersection point between the second ray l₂ and the plane a is the point t₂ on the second ray l₂ closest to the first ray l₁. Merely by way of example, the intersection point t₂ may be determined by Equation (36):

$${t}_{2} = {p}_{2} + \frac{( {p}_{1} - {p}_{2} ) \cdot {f}_{1}}{{v}_{2} \cdot {f}_{1}} {v}_{2} , \qquad ( 36 )$$

where ƒ₁ denotes a vector perpendicular to the plane b formed by the first ray l₁.

In some embodiments, the processor may connect the intersection point t₁ between the ray l₁ and the plane a with the intersection point t₂ between the second ray l₂ and the plane a, and determine the center position of the line segment connecting the two intersection points as the position of the target source.

In some embodiments, MATLAB software may be used for result simulation. Simulation parameters may include the following.

In the distributed array model, the centers of the two RIS transmissive array surfaces are set as [0 0 0]^{T} and [0 3 0]^{T}, respectively. A receiving antenna is placed behind each RIS transmissive array surface, located at [0 0−λ]^{T} and [0 3−λ]^{T} directly below the transmissive array surfaces. The signal operating frequency is 28 GHz, the signal source transmission power is set to 1 mW, the power spectral density of noise is set to −174 dBm/Hz, and the receiver noise figure is 8 dB. The bandwidth is set to 1 MHz to facilitate positioning based on 0.2 ms of observations. Prior information of a user position is modeled using a Gaussian probability density function ƒ(p)= [symbol] (p; mₚ, Σₚ), wherein Σₚ=σ²I₃. The prior information is used in the design of RIS phases and is not involved in the positioning process and PEB calculation. N=5 is used for extended position estimation. To eliminate the influence of the count of array elements on positioning performance, a single RIS transmissive array surface may have 50×50 array elements in the position estimation process, and each of the two array surfaces in the distributed array model has 35×35 array elements. To reduce errors caused by the randomness of a single simulation, the RMSE value for each position in the simulation is obtained by averaging results of 200 Monte Carlo trials.

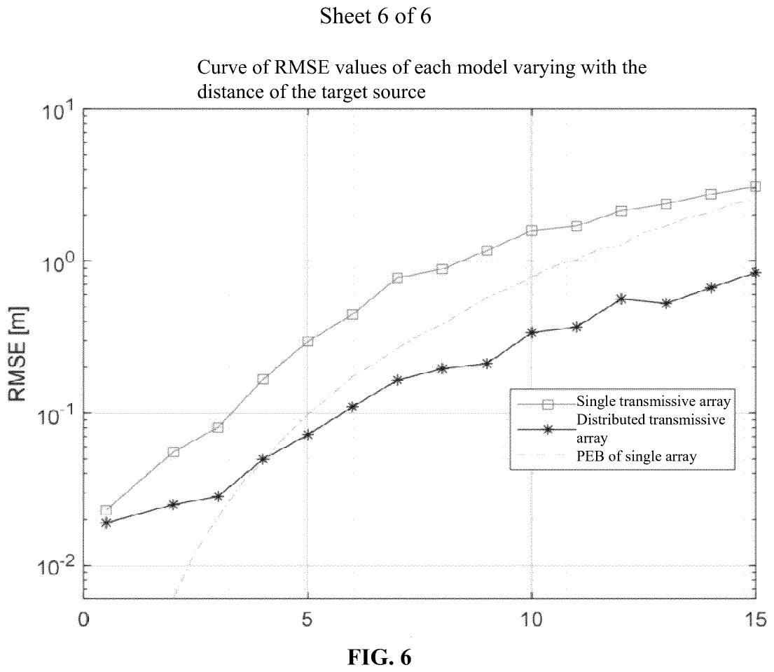

FIG. 6 is a performance comparison diagram between the system of the present disclosure and a single RIS-assisted positioning system during simulation verification according to some embodiments of the present disclosure.

In some embodiments, as shown in FIG. 6, the positioning performance of the positioning model based on the distributed RIS transmissive array is generally superior to that of the existing single RIS transmissive array model, indicating that the model designed in the present disclosure and the proposed positioning algorithm are superior to the existing single array model. Meanwhile, time consumed by simulation using MATLAB software is also better than that of the single array model. Specifically, the simulation time of the distributed model is approximately ¼ of that of the single array model.

In some embodiments, a plurality of distributed RIS transmissive arrays may be disposed on the surface of a building in a smart factory. The smart factory is equipped with an Automated Guided Vehicle (AGV) and includes a processor. The processor is in communication connection with the RIS transmissive arrays and the AGV. In some embodiments of the present disclosure, the method for target position estimation based on the distributed RIS transmissive array is executed by the processor.

In some embodiments, a miniature signal transmitter is installed on the AGV. The miniature signal transmitter may serve as the target source.

In some embodiments, the method for target position estimation based on a distributed RIS transmissive array further includes: determining a current path of the AGV based on the position of the target source, updating a movement parameter of the AGV based on a relationship between the current path of the AGV and a preset path, and controlling the AGV to move to an end position of the preset path based on an updated movement parameter.

In some embodiments, the plurality of distributed RIS transmissive arrays may be disposed on a wall or ceiling of the smart factory. In some embodiments, the plurality of distributed RIS transmissive arrays may also be disposed on surfaces of other buildings.

In some embodiments, the processor may take the AGV equipped with the miniature signal transmitter as the target source.

The position of the target source refers to coordinates of a device to be positioned in three-dimensional space. In some embodiments, the processor may take the position of the AGV as the position of the target source.

In some embodiments, the processor may connect a plurality of positions of the AGV over a period of time to form the current path of the AGV.

The preset path refers to a pre-planned movement route that reaches the end position at a specific time. For example, in the smart factory, the preset path may be automatically generated based on a destination of the AGV.

The movement parameter of the AGV refers to a quantitative indicator describing a movement state of the AGV. In some embodiments, the movement parameter of the AGV may include a linear velocity, an angular velocity, an acceleration, a position coordinate, or the like.

In some embodiments, the processor may update the movement parameter of the AGV in various ways based on the relationship between the current path of the AGV and the preset path.

For example, in response to an offset value of the current path of the AGV relative to the preset path being less than an offset threshold, the processor does not update the movement parameter of the AGV. In response to the offset value of the current path of the AGV relative to the preset path being greater than the offset threshold, the processor updates the movement parameter of the AGV by querying a preset table based on the offset value. The preset table includes a plurality of corresponding relationships between offset values and updated movement parameters. The preset table may be constructed by a technician based on historical data. The offset threshold may be preset by the technician based on experience.

In some embodiments, the processor controls the AGV to move to the end position of the preset path based on the updated movement parameters.

In some embodiments of the present disclosure, by installing the plurality of distributed RIS transmissive arrays on the surfaces of buildings in the smart factory, signal transmission problems caused by building occlusion can be effectively avoided, the position information of the target source on the AGV can be accurately captured and transmitted to the processor, which greatly improves the positioning accuracy of the AGV, thereby providing a reliable basis for positioning-based path planning, movement parameter update, and precise control. This approach ensures that the AGV can move to the end position along the preset path more stably and efficiently, thus significantly optimizing the automated operation efficiency of the smart factory.

In some embodiments, the processor may be further configured to determine activation times of the plurality of distributed RIS transmissive arrays based on installation positions of the plurality of distributed RIS transmissive arrays, a plurality of preset paths of the AGV, and obstacle information of the smart factory; and control the activation of one or more of the plurality of distributed RIS transmissive arrays based on the activation times.

The installation positions of the plurality of distributed RIS transmissive arrays refer to locations at which the plurality of distributed RIS transmissive arrays are installed in the smart factory. The installation positions of the plurality of distributed RIS transmissive arrays may be preset by the technician based on experience.

The obstacle information of the smart factory refers to information about obstacles in the smart factory that may affect signal transmission. For example, the obstacle information includes walls, devices that may cause interference, or the like. In some embodiments, the obstacle information may be preset by the technician. For example, the obstacle information is input by the technician.

When the AGV is not operating, or the AGV is moving but there are no obstacles or the AGV has not moved to an area with obstacles, the plurality of distributed RIS transmissive arrays may enter a dormant state, switch to a low-power mode, or be turned off to reduce energy consumption. The activation time refers to a time at which the plurality of distributed RIS transmissive arrays are activated to work.

In some embodiments, the processor may determine the activation times of the plurality of distributed RIS transmissive arrays through an energy-saving model based on the installation positions of the plurality of distributed RIS transmissive arrays, the plurality of preset paths of the AGV, and the obstacle information of the smart factory.

The energy-saving model refers to a model configured to determine the activation times. In some embodiments, the energy-saving model may be a machine learning model. For example, the energy-saving model includes a neural network (NN), a custom model structure, or the like, or any combination thereof.

In some embodiments, an input of the energy-saving model may include the installation positions of the plurality of distributed RIS transmissive arrays, the plurality of preset paths of the AGV, and the obstacle information of the smart factory. An output of the energy-saving model may be the activation time of each distributed RIS transmissive array.

In some embodiments, the plurality of preset paths of the AGV may include preset paths for the AGV to reach different destinations at different time points. For example, the plurality of preset paths of the AGV may be that the AGV reaches destination A at time point 1, destination B at time point 2, destination C at time point 3, and so on.

In some embodiments, the energy-saving model may be obtained through training based on first training samples with first labels. In some embodiments, the first training samples may include sample installation positions of a plurality of sample distributed RIS transmissive arrays, a plurality of sample preset paths of a sample AGV, and sample obstacle information of a sample smart factory. The first labels are the actual activation times of the plurality of sample distributed RIS transmissive arrays.

In some embodiments, the first training samples and the first labels may be determined based on preferred historical data of the sample AGV. The preferred historical data refers to historical data where an AGV path correction frequency is less than a correction threshold and a count of AGV stagnation/failure events is less than a failure count threshold. The correction threshold and the failure count threshold may be preset by the technician based on experience. The preferred historical data may be obtained through annotation by the technician.

The AGV path correction frequency refers to a count of times the processor updates the movement parameter of the AGV. The AGV stagnation/failure events refer to stagnation or failure events of the AGV caused by poor communication, positioning failure, or path problems. In some embodiments, the AGV path correction frequency and AGV stagnation/failure events may be directly obtained by the processor based on the preferred historical data. For example, the AGV path correction frequency and AGV stagnation/failure events are determined through statistics based on the preferred historical data.

For example, the processor may take historical installation positions of the plurality of distributed RIS transmissive arrays, the plurality of historical preset paths of the AGV, and historical obstacle information of the smart factory in the preferred historical data as the first training samples, and take the actual historical activation times of the distributed RIS transmissive arrays as the first labels.

In some embodiments, the processor may perform training through various manners based on the training samples and the labels. For example, the processor performs training based on a gradient descent manner. Merely by way of example, the processor may input a plurality of labeled training samples into an initial energy-saving model, construct a loss function based on the labels and results of the initial energy-saving model, and iteratively update parameters of the initial energy-saving model based on the loss function. When the loss function of the initial energy-saving model meets a preset condition, the model training is completed, and the trained energy-saving model is obtained. The preset condition may be that the loss function converges, a count of iterations reaches a threshold, or the like.

In some embodiments, the processor may control activation of one or more of the plurality of distributed RIS transmissive arrays based on the activation time of each distributed RIS transmissive array.

In some embodiments of the present disclosure, by determining the activation times based on the installation positions of the plurality of distributed RIS transmissive arrays, the plurality of preset paths of the AGV, and the obstacle information of the smart factory, and controlling the activation of the arrays accordingly, the distributed RIS transmissive arrays can be put into the dormant state, enter the low-power mode, or even be turned off in a timely manner when the AGV is not operating, or the AGV is moving but has not encountered obstacles or entered an area with obstacles. Thereby, energy waste caused by continuous operation of the arrays in scenarios where they are not needed is avoided, significantly reducing the overall energy consumption of the system. Meanwhile, the positioning performance of the AGV when precise positioning is required remains unaffected. This approach ensures the efficient and accurate operation of AGV in the smart factory while achieving rational energy utilization and optimization of system operational costs.

One or more embodiments of the present disclosure further provides a non-transitory computer-readable storage medium that stores computer instructions. When a computer reads the computer instructions in the storage medium, the computer executes the method for target position estimation based on the distributed RIS transmissive array as described in any one of the above embodiments.

The drawings used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

The descriptions of the system and its modules in the embodiments of the present disclosure are only for convenience of description and are not limited to the scope of the enumerated embodiments. It may be possible to make any combination of modules or form a sub-system to connect with other modules without departing from the principles of the system.

It should be noted that the above descriptions are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

The particular features, structures, or characteristics may be combined as suitable in one or more embodiments of the present disclosure.

Aspects of the present disclosure may be implemented entirely hardware, entirely software (including firmware, resident software, micro-code, etc.) or combining software and hardware implementation that may all generally be referred to herein as a “unit”, “module”, or “system”. The above hardware or software can be referred to as “data block”, “module”, “engine”, “unit”, “component”, or “system”, etc. Furthermore, aspects of the present disclosure may take the form of a computer program product embodied in one or more computer-readable media having computer-readable program code embodied thereon.

The computer storage medium may be any computer-readable medium that may communicate, propagate, or transmit a program for use by connecting to an instruction execution system, device, or equipment. The program code located on the computer storage medium may be propagated through any suitable medium, including radio, cable, fiber optic cable, RF, or similar media, or any combination of the above media.

The computer program code required for the operations of each part of the present disclosure may be written in any one or more programming languages. The program code may be run entirely on the user's computer, run as an independent software package on the user's computer, run partially on the user's computer and partially on a remote computer, or run entirely on the remote computer or processing device. In the latter case, the remote computer may be connected to the user's computer through any form of network, such as a local area network (LAN) or a wide area network (WAN), or connected to an external computer (for example, through the Internet), or in a cloud computing environment, or used as a service such as Software as a Service (SaaS).

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teachings of the present disclosure. Accordingly, the embodiments of the present disclosure are not limited to the embodiments introduced and described in the present disclosure explicitly.

1. A method for target position estimation based on a distributed reconfigurable intelligent surface (RIS) transmissive array, comprising:
configuring distributed RISs as an RIS transmissive array, wherein the distributed RISs include two RIS transmissive array surfaces, a target source and receiving radio frequency (RF) chains are respectively disposed on two sides of the RIS transmissive array, the receiving RF chains are connected to receiving antennas, and the target source emits a pilot signal into space;
transmitting the pilot signal through the RIS transmissive array to the receiving RF chains to obtain a received signal;
determining an azimuth angle β and an elevation angle α of the target source relative to each of the two RIS transmissive array surfaces by processing the received signal; and
constructing two rays respectively passing through centers of the two RIS transmissive array surfaces based on the azimuth angles β and the elevation angles α of the target source relative to the two RIS transmissive array surfaces, determining a median of a shortest distance between the two rays, and determining a position of the median as a position of the target source;
the method further comprising:
constructing a distributed RIS transmissive array-assisted positioning system, including:
arranging the two RIS transmissive array surfaces side-by-side to form the RIS transmissive array, wherein each of the two RIS transmissive array surfaces is connected to a receiving antenna RF, the two receiving antennas RF and the target source are respectively located on the two sides of the RIS transmissive array, each of the two RIS transmissive array surfaces includes M array elements, and a position of an i-th array element is expressed as:
qᵢ=[xᵢ,yᵢ,zᵢ]^{T},xᵢ,yᵢ∈R³,zᵢ>0,i=1,2, . . . ,M,[xᵢ,yᵢ,zᵢ]T=rᵢ[cosψᵢ sinψᵢ0]^{T}
where qᵢ denotes the position of the i-th array element, i denotes an index of the array element, M denotes a count of array elements in each RIS transmissive array surface, R³ denotes a set of real numbers in three dimensions, [xᵢ, yᵢ, zᵢ] denote coordinates, rᵢ denotes a distance between the i-th array element and the center of the RIS transmissive array surface, ψᵢ denotes an azimuth angle between a line connecting the i-th array element and an origin and a positive direction of an X axis, T denotes a transpose operation;
a position vector of the target source is expressed as:
$$p = - \frac{λ d {c}_{g} ( {α}_{g} , {β}_{g} )}{2 π} ( g = 1 , 2 ) ,$$
$${c}_{g} ( {α}_{g} , {β}_{g} ) = - \frac{2 π}{λ} [ \begin{matrix}\begin{matrix}sin {α}_{g} & cos {β}_{g}\end{matrix} \\ \begin{matrix}sin {α}_{g} & sin {β}_{g}\end{matrix} \\ cos {α}_{g}\end{matrix} ] ( g = 1 , 2 ) ,$$
where p denotes the position vector of the target source, λ denotes a wavelength of the pilot signal, d denotes a Euclidean distance from the target source to the center of one of the RIS transmissive array surfaces, c_{g}(α_{g}, β_{g}) denotes a wave vector of the pilot signal arriving at a g-th RIS transmissive array surface, α_{g} denotes an elevation angle between the pilot signal and the g-th RIS transmissive array surface, β_{g} denotes an azimuth angle between the pilot signal and the g-th RIS transmissive array surface.

2. (canceled)

3. The method of claim 1, wherein after the pilot signal emitted by the target source is transmitted through a wireless channel, an output signal of the receiving antenna is expressed as:
$${y}^{′} = \sqrt{{E}_{s}} γ {W}^{⊤} {G}^{⊤} ( α ) h ( β ) + n ,$$
$$where :$$
$$W = [ {ω}_{1} , {ω}_{2} , ⋯ , {ω}_{T} ] ,$$
$${ω}_{t} = {Ω}_{t} {g}_{ant} , t = 1 , 2 , ⋯ , T ,$$
$$G ( α ) = [ {g}_{0} ( α ) ⋯ {g}_{M - 1} ( α ) ] ,$$
$$h ( β ) = {e}^{j β} ,$$
wherein y′ denotes the output signal of the receiving antenna, also referred to as the received signal, E_{S} denotes an average power of the pilot signal, γ denotes an intermediate variable, γ=ζ(p)e^{jθ}, ζ(p) denotes an amplitude vector of the wireless channel between the RIS transmissive array surface and the target source, e denotes a base of a natural logarithm, j denotes an imaginary unit, θ denotes a signal phase,
$$θ = - \frac{2 π d}{λ} + {θ}_{offset} ,$$
λ denotes a wavelength of the pilot signal, d denotes a Euclidean distance from the target source to the center of one of the RIS transmissive array surfaces, θ_{offset} denotes a global phase offset, ωₜ denotes a product of an array element phase and a channel gain at a time point t, W denotes a set composed of ωₜ, T denotes a count of time points, T denotes a transpose operation, α denotes the elevation angle between the pilot signal and one of the RIS transmissive array surfaces, G(α) denotes an intermediate variable related to the elevation angle α, ββ denotes the azimuth angle between the pilot signal and one of the RIS transmissive array surfaces, n denotes a noise vector.

4. The method of claim 3, wherein
the intermediate variable G(α) is expressed as: G(α)=[g₀(α) . . . g_{M-1}(α)], where an i-th element gᵢ(α) related to the elevation angle α is expressed as:
$${g}_{i} ( α ) = {j}^{n} {J}_{n} ( - \frac{2 π}{λ} {r}_{i} sin ( α ) ) {e}^{- jn {ψ}_{i}} , i = 0 , ⋯ , M - 1$$
where gᵢ(α) denotes the i-th element of the intermediate variable gᵢ (α) related to the elevation angle α, i denotes an index of the array element, M denotes a count of array elements in each RIS transmissive array surface, Jₙ(·) denotes an n-th order Bessel function, with n=2, j denotes the imaginary unit, ψᵢ denotes an azimuthal coordinate of an i-th array element, rᵢ denotes a distance from the i-th array element to the center of the RIS transmissive array.

5. The method of claim 3, wherein the determining an azimuth angle β and an elevation angle α of the target source relative to each of the two RIS transmissive array surfaces by processing the received signal includes:
obtaining an optimization function for the elevation angle α based on the expression of the output signal of the receiving antenna, and obtaining an estimated value of the elevation angle α by performing a grid search over a range of 0° to 90° for the elevation angle, wherein the optimization function for the elevation angle α is expressed as:
$$α = arg {min}_{α} {‖ {y}^{′} - {W}^{⊤} {G}^{⊤} ( α ) \hat{v} ( α ) ‖}^{2} ,$$
$$where$$
$$v ( α ) = ( {G}^{*} ( α ) {W}^{*} ) + {G}^{*} ( α ) {W}^{*} {y}^{′}$$
wherein y′ denotes the output signal of the receiving antenna, α denotes the estimated value of the elevation angle α, ∥·∥ denotes Euclidean distance calculation, \hat{ν}(α) denotes an estimated value represented as a function of the elevation angle α, G*(α) denotes a complex conjugate of G(α), W* denotes a complex conjugate of W;
substituting the estimated value of the elevation angle α into the transformed expression of the output signal of the receiving antenna, obtaining an optimization function for the azimuth angle β, and obtaining an estimated value of the azimuth angle β by performing a grid search over a range of 0° to 360⁰ for the azimuth angle β, wherein the optimization function for the azimuth angle β is expressed as:
$$\hat{β} = arg {min}_{β} {‖ {y}^{′} - \sqrt{{E}_{s}} \hat{γ} ( β ) {W}^{⊤} {G}^{⊤} ( \hat{α} ) h ( β ) ‖}^{2} ,$$
where y′ denotes the output signal of the receiving antenna, \hat{β} denotes the estimated value of the azimuth angle β, \hat{γ}(β) denotes a maximum likelihood estimate (MLE) of γ with respect to the azimuth angle β.

6. The method of claim 5, wherein a process of constructing the optimization function for the azimuth angle β includes:
building a maximum likelihood estimation model, letting γ=ζ(p)e^{jθ} to obtain an MLE of the channel gain and an MLE of the position of the target source, expressed as:
$$[ \hat{γ} , \hat{p} ] = arg {max}_{γ , p} f ( {y}^{′} \vert γ , p ) = arg {min}_{γ , p} {‖ {y}^{′} - \sqrt{{E}_{s}} γ {W}^{⊤} b ( p ) ‖}^{2} ,$$
where \hat{γ} denotes the MLE of the channel gain, and \hat{p} denotes the MLE of the position of the target source;
solving for an MLE of γ with respect to the position p of the target source based on the MLE of the channel gain using the following equation:
$$\hat{γ} ( p ) = \frac{{b}^{H} ( p ) {W}^{*} {y}^{′}}{\sqrt{{E}_{s}} {‖ {W}^{⊤} b ( p ) ‖}^{2}} ,$$
where W* denotes the complex conjugate of W, b^{H}(p) denotes a conjugate transpose of b(p), b(p)=G^{T}(\hat{α})h(β),
solving for an MLE of γ with respect to the azimuth angle β based on the MLE \hat{γ}(p) of γ with respect to the position p of the target source using the following equation:
$$\hat{γ} ( β ) = \frac{{b}^{H} ( p ) {W}^{*} {y}^{′}}{\sqrt{{E}_{s}} {‖ {W}^{⊤} {G}^{⊤} ( \hat{α} ) h ( β ) ‖}^{2}} ,$$
where \hat{γ}(β) the MLE of γ with respect to the azimuth angle β, G^{T}(\hat{α}) denotes a transpose of G(\hat{α}).

7. (canceled)
